(19) United States
(12) Patent Application Publication
(10) Pub. No.: US 2022/0040875 A1
(43) Pub. Date: Feb. 10, 2022

(54) Chopping Apparatus for Hot Peppers

(71) Applicant: Primon Investments Ltd., Winnipeg (CA)

(72) Inventor: Pankaj Kumar Sharma, Winnipeg (CA)

(21) Appl. No.: 17/384,064

(22) Filed: Jul. 23, 2021

Related U.S. Application Data
(60) Provisional application No. 63/060,891, filed on Aug. 4, 2020.

(51) Int. Cl. B26D 3/26; B26D 5/10; B26D 1/09

(52) U.S. Cl. CPC B26D 3/26; B26D 2001/0033; B26D 1/09; B26D 5/10

(57) ABSTRACT

A chopping apparatus for chopping a food item has a lower body portion and an upper body portion hinged together such that a hinge axis is perpendicular to the longitudinal directions of the body portions. Blades are supported on the upper body portion opposite a supporting surface on the lower body portion so as to be arranged to chop a food item supported on the supporting surface when the body portions are closed towards one another. The blades include lateral blades that are oriented perpendicularly to the longitudinal direction of the body portions and generally parallel to the hinge axis.

This application claims the benefit under 35 U.S.C. 119(e) of U.S. provisional application Ser. No. 63/060,891, filed Aug. 4, 2020.

### FIELD OF THE INVENTION

The present invention relates to chopping apparatus for use in food preparation to chop a food item, and more particularly the present invention relates to a chopping apparatus that is particularly suited for chopping a hot pepper.

### BACKGROUND

When chopping a hot pepper, for example by slicing or dicing, it is common for juices and/or oils from the pepper to come into contact with the fingers of the person chopping. Residual juices or oils on the fingers of the person can then be inadvertently transferred to the face of the user through regular contact between the hands and face of the user, which can cause considerable discomfort to the person particularly if contact is made near the eyes.

Various devices have been proposed for efficiently chopping various food items, but known devices are not well suited specifically for chopping a hot pepper in a manner that ensures minimal or no contact with the hands of the user to effect the chopping.

### SUMMARY OF THE INVENTION

According to one aspect of the invention there is provided a chopping apparatus for chopping a food item, the apparatus comprising:

a lower body portion which is elongate in a first longitudinal direction between a first end and an opposing second end of the lower body portion so as to define a lower longitudinal axis extending between the first end and the second end of the lower body portion;

an upper body portion which is elongate in a second longitudinal direction between a first end and an opposing second end of the upper body portion so as to define an upper longitudinal axis extending between the first end and the second end of the upper body portion;

a hinge coupled between the first end of the lower body portion and the first end of the upper body portion, the hinge defining a hinge axis that is perpendicular to the first and second longitudinal directions such that the upper body portion is pivotal relative to the lower body portion between (i) a closed position in which the upper body portion lies substantially parallel to and alongside the lower body portion, and (ii) an open position in which the upper body portion diverges away from the lower body portion from the first end towards the second end thereof;

a supporting surface on the lower body portion, the supporting surface facing towards the upper body portion and being arranged to support the food item thereon, and the supporting surface being curved about a longitudinal axis oriented in the first longitudinal direction so as to be concave and partly cylindrical in shape;

a plurality of blades supported on the upper body portion, each blade extending towards the lower body portion from an upper end mounted on the upper body portion to a lower end defining a cutting edge thereon;

the blades being spaced apart from the supporting surface in the open position so as to be arranged to receive the food item between the blades and the supporting surface;

the blades being located in close proximity to the supporting surface in the closed position so as to be arranged to chop the food item supported on the supporting surface.

The curvature of the supporting surface about a long axis of the body portions together with the hinge located at one end of the body portions allows a hot pepper to be effectively supported during chopping, while also enabling the chopped pepper to be readily and controllably discharged through an open end of the body portions opposite the hinge without any direct contact by the hands of the user being required. This minimizes or eliminates the possibility of juices and or oils from the hot pepper being transferred to the face of the person chopping.

Preferably the blades are supported on a frame and the frame is slidably received into a channel on the upper body portion so as to be readily releasable from the upper body portion. The channel may support the frame for sliding in the second longitudinal direction of the upper body portion.

The supporting surface may be formed on a base member received into a channel on the lower body portion so as to be readily releasable from the lower body portion.

In some embodiments, at least some of the blades that are in proximity to the second end of the upper body portion protrude farther from the second longitudinal axis of the upper body portion than at least some of the blades that are in proximity to the first end of the upper body portion.

The apparatus may further include a handle member fixedly attached to a supporting body portion comprising one of the upper body portion and the lower body portion, the handle member extending in the longitudinal direction of the supporting body portion diametrically opposite to the supporting surface in relation to the hinge axis.

Preferably the blades comprise lateral blades oriented perpendicularly to the second longitudinal direction of the upper body portion upon which the blades are supported.

In some embodiments, the supporting surface includes a plurality of slots formed therein in which the slots receive the lateral blades therethrough in the closed position of the upper body portion relative to the lower body portion.

In further embodiments, the supporting surface is continuous and uninterrupted along a length of the supporting surface in the first longitudinal direction of the lower body portion.

When the supporting surface is continuous, the blades may include longitudinal blades and the lateral blades arranged in an intersecting manner to define a mesh, in which the mesh has a convex lower boundary similar in shape to the supporting surface on the lower body portion and a concave upper boundary. The mesh is preferably spaced below a central portion of the upper body portion to define a collection space above the concave upper boundary of the blades in which the collection space is arranged to receive chopped pieces of the food item therein once the mesh has passed through the food item as a result of displacement of the upper body portion into the closed position.

Alternatively, when the supporting surface is continuous, the blades may comprise an array of elongate fingers arranged in longitudinally spaced apart rows in which the fingers all terminate at a lower boundary that is similar in shape to the supporting surface such that all of the fingers are arranged to engage the supporting surface in the closed position of the upper body portion relative to the lower body portion.

### BRIEF DESCRIPTION OF THE DRAWINGS

Various embodiments of the invention will now be described in conjunction with the accompanying drawings in which:

FIG. 1 is a perspective view of the chopping apparatus according to a first embodiment of the present invention;

FIG. 2 is a side elevational view of the chopping apparatus according to the first embodiment of FIG. 1;

FIG. 3 is a top plan view of the chopping apparatus according to the first embodiment of FIG. 1;

FIG. 4 is an end elevational view of the chopping apparatus according to the first embodiment of FIG. 1;

FIG. 5 is an end elevational view of the blades of the upper body portion and the supporting surface of the lower body portion, shown removed from the upper and lower body portions according to the first embodiment of the blades shown in FIG. 1;

FIG. 6 is a side elevational view of the blades of the upper body portion and the supporting surface of the lower body portion, shown removed from the upper and lower body portions according to the first embodiment of the blades shown in FIG. 1;

FIG. 7 is a side elevational view of the blades according to a second embodiment of the blades;

FIG. 8 is a perspective view of the blades of the upper body portion and the supporting surface of the lower body portion, shown removed from the upper and lower body portions according to a third embodiment of the blades;

FIG. 9 is an end elevational view of the blades of the upper body portion and the supporting surface of the lower body portion, shown removed from the upper and lower body portions according to a fourth embodiment of the blades; and

FIG. 10 is a side elevational view of the blades according to the fourth embodiment of FIG. 9.

In the drawings like characters of reference indicate corresponding parts in the different figures.

### DETAILED DESCRIPTION

Referring to the accompanying figures, there is illustrated a hot pepper chopping apparatus generally indicated by reference numeral 10. The chopping apparatus 10 is particularly suited for chopping a hot pepper, either by slicing the hot pepper with a series of laterally oriented cuts across the long axis of the pepper to produce a series of generally circular slices or by dicing the hot pepper into an array of cut pieces.

The chopping apparatus 10 generally comprise a main body formed by a lower body portion 12 and an upper body portion 14 which are movable relative to one another to receive and chop the hot pepper therebetween. The lower body portion 12 defines a supporting surface upon which a food item can be supported, while the upper body portion 14 defines blades which cut the food item as the blades are displaced towards the supporting surface. A plurality of different supporting surfaces and different configurations of blades can be interchangeably supported on the lower body portion and the upper body portion as described in further detail below. The common features of the various configurations will first be described herein.

Each of the lower body portion 12 and the upper body portion 14 comprise a rigid body of molded plastic material which is generally elongated between first ends 16 which are joined together by a hinge 18 and opposing second ends 20 which are movable relative to one another between open and closed positions of the apparatus described in further detail below. The outer surface of the lower body portion and the upper body portion combined form an elongated ellipsoid shape in which the body portions are separated from one another at a plane occupying a longitudinal axis of the ellipsoid.

The hinge 18 coupling the first ends of the lower body portion 12 and the upper body portion 14 effectively couples the body portions such that they are pivotal relative to one another about a hinge axis of the hinge which is oriented perpendicularly to the longitudinal direction of the apparatus. More particularly, in a closed position a first longitudinal axis of the lower body portion extending between the opposing first and second ends of the lower body portion lies approximately parallel to a second longitudinal axis of the upper body portion extending between the opposing first and second ends of the upper body portion. Accordingly the upper and lower body portions in the closed position are generally parallel and alongside one another along the full length of the main body.

Alternatively in the open position, the upper body portion is pivoted relative to the lower body portion such that the second end of the upper body portion is displaced away from the second end of the lower body portion. In the open position the upper and lower body portions are sufficiently separated to receive a food item such as a hot pepper therebetween due to the first and second longitudinal axes of the respective lower and upper body portions diverging away from one another from the first ends towards the second ends which are spaced apart.

In the illustrated embodiment, the hinge 18 is defined by flexible plastic material that may be joined to or integrally moulded seamlessly together with the plastic material of the upper and lower body portions. In either instance, the hinge functions by allowing the plastic material to be resiliently deformed as the upper body portion is displaced from the closed position towards the open position relative to the lower body portion.

In alternative embodiments, the hinge may comprise a pivot shaft that defines the hinge axis and which is rotatably coupled to one or both of the upper body portion or the lower body portion to define the pivoting movement as the apparatus is displaced between the open and closed positions.

A handle member 22 is fixed relative to the lower body portion to extend generally in the direction of the first longitudinal axis away from the lower body portion at a location diametrically opposite to the lower portion in relation to the hinge axis. The handle member 22 may comprise an elongated rigid shaft having a curved end portion 24 forming a hook. An aperture 26 may extend through the curved end portion 24. In this instance the handle member can be grasped in the hand of a user to provide stability to the lower body portion as the upper body portion is displaced from the open position to the closed position to perform a chopping action of a food item received within the apparatus. The handle member can also be used for hanging the apparatus therefrom when not in use either by hooking the handle onto a supporting object or by use of the aperture 26 which can receive a supporting hook or pin therethrough.

The outer surface of the upper and lower body portions together with the handle member generally forms the shape of a hot pepper in which the body portions 12 and 14 represent a body of the pepper and the handle member 22 represents a stem extending outward from a top end of the pepper along a longitudinal axis of the hot pepper.

The lower body portion 12 has an inner side facing towards the upper body portion which forms a mounting channel 28a therein that extends along the full length of the lower body portion along the first longitudinal axis thereof. The cross-sectional shape of the mounting channel includes a main channel portion 30a defining a first width between parallel and opposed side walls of the channel. The mounting channel 28a further includes a lower channel portion 32a which is wider in the lateral direction to define a second width that is wider than the first width of the main channel portion 30a. The lower channel portion is formed by a pair of lower grooves which are formed below the opposing side walls of the main channel portion 30a to extend laterally outward in relation thereto. In this manner the lower channel portion 32a and the main channel portion 30a collectively form a generally T shaped cross-sectional profile of the mounting channel.

A base member 34 is supported within the mounting channel 28a of the lower body portion for supporting the food item thereon for chopping. The base member 34 includes a lower frame portion 35 having a pair of laterally protruding flanges along opposing sides of the base member 34 having a thickness and defining an overall lateral width which closely matches the thickness of the lower grooves and the overall second width of the lower channel portion 32a. The remainder of the base member 34 has a lateral width which closely fits between the sidewalls of the main channel portion 30a of the mounting channel 28a. In this manner, the base member 34 fits within the mounting channel 28a such that the base member is longitudinally slidable within the mounting channel in the direction of the first longitudinal axis of the lower body portion 12. The mounting channel 28a is open at the second end of the lower body portion such that the base member 34 can be readily slidably removed from the second end of the lower body portion by longitudinal sliding.

An inner side of the base member 34 defines a supporting surface 36 thereon upon which the food item is supported during a chopping action. The supporting surface 36 fully spans a top side of the base member 34 for spanning substantially the full length of the lower body portion and a mounted position of the base member thereon. The supporting surface is generally curved about the first longitudinal axis of the lower body portion so as to be generally concave in the lateral direction and so as to form part of the surface of a cylinder in its shape. The concave supporting surface 36 faces towards the upper body portion. The curvature of the supporting surface 36 is arranged to support a food item such as a hot pepper thereon such that a long axis of the food item is aligned with the first longitudinal axis of the lower body portion.

The upper body portion 14 also has an inner side facing towards the lower body portion which forms a similar mounting channel 28b therein that extends along the full length of the upper body portion along the second longitudinal axis thereof. The cross-sectional shape of the mounting channel 28b of the upper body portion includes a main channel portion 30b defining a first width between parallel and opposed side walls of the channel. The mounting channel 28b further includes an upper channel portion 32b which is wider in the lateral direction to define a second width that is wider than the first width of the main channel portion 30b. The upper channel portion 32b is formed by a pair of upper grooves which are formed above the opposing side walls of the main channel portion 30b to extend laterally outward in relation thereto. In this manner the upper channel portion 32b and the main channel portion 30b collectively form a generally T shaped cross-sectional profile of the mounting channel of the upper body portion 14.

A blade assembly 38 is supported within the mounting channel 28b of the upper body portion to perform the cutting of the food item supported on the base member of the lower body portion. The blade assembly includes an upper frame portion 40 which functions as a common frame member for supporting a plurality of individual blades 42 of the blade assembly thereon such that the blades are supported in fixed relation to one another by connection to the frame member 40 and such that the blades 42 can be mounted onto and readily removed from the upper body portion collectively with the frame member. The upper frame portion 40 defines a pair of laterally protruding flanges along opposing sides of the blade assembly having a thickness and defining an overall lateral width which closely matches the thickness of the upper grooves and the overall lateral width of the upper channel portion 32b. The mounting channel 28b in the upper body portion is open at the second end of the upper body portion such that the blade assembly can be readily slidably removed from the second end of the upper body portion by longitudinal sliding.

In each instance, the blades 42 of the blade assembly 38 protrude from the frame member 40 towards the opposing lower body portion 12 so as to terminate at respective lower free ends defining cutting edges thereon. The cutting edges of the plurality of blades typically lie in a common lower boundary of the blades which cooperates with the supporting surface as the blades are displaced from an open position to a closed position of the apparatus for chopping of the food item.

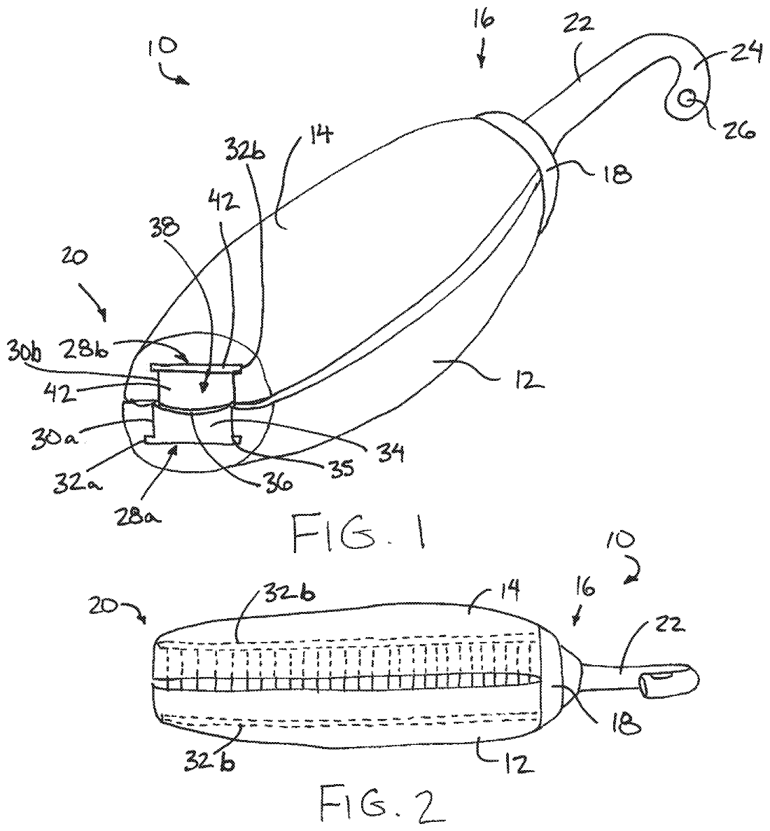

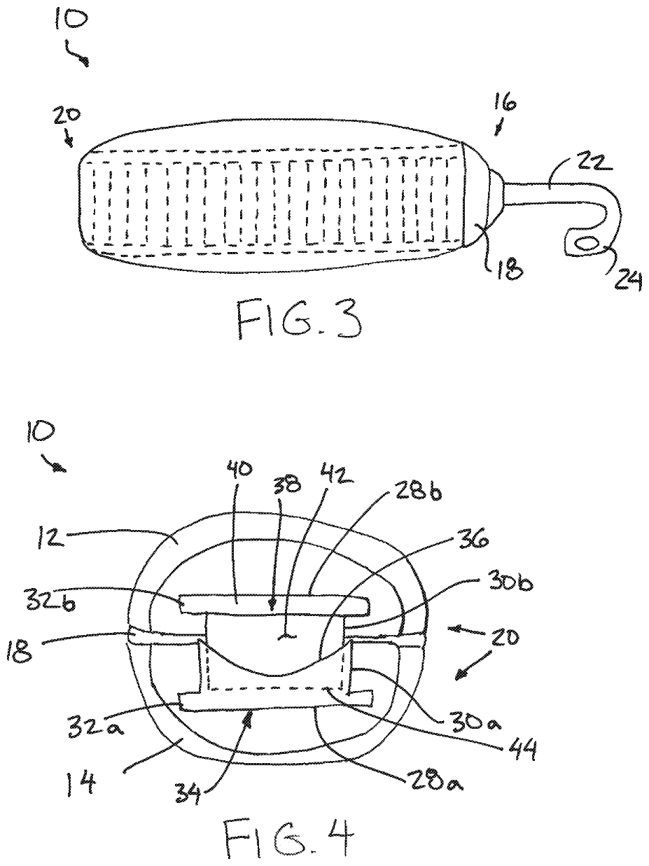

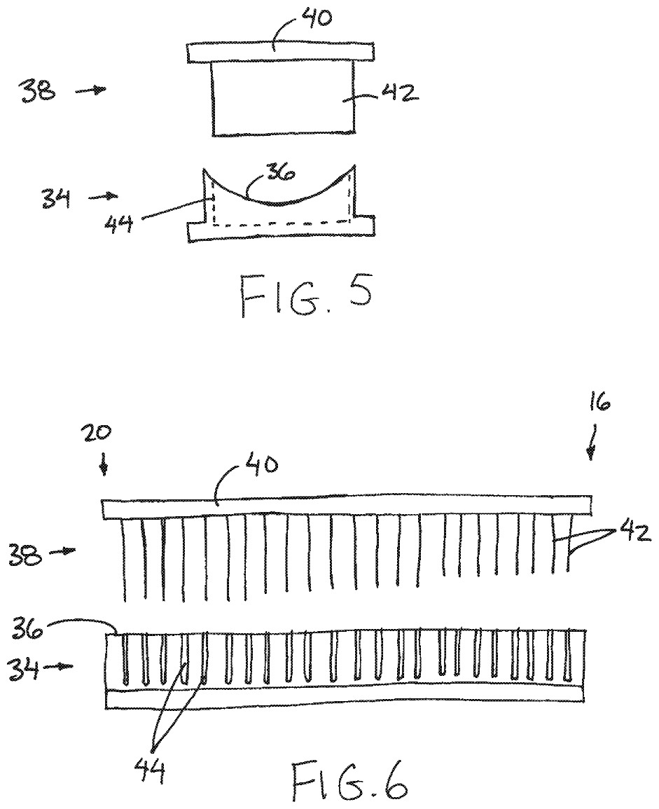

Turning now to the first embodiment shown in FIGS. 1 through 6, in this instance the blades all comprise lateral blades that are oriented perpendicularly to the second longitudinal axis of the upper body portion. Each blade spans substantially the full width of the blade assembly such that the blades are oriented in a single longitudinally extending row with the blades being evenly spaced apart from one another in the longitudinal direction. An overall length of the blades is such that all of the blades protrude through and below the supporting surface 36 on the lower body portion in the closed position. This is accomplished by a plurality of blade slots 44 formed in the base member 34.

More particularly, the base member 34 in this instance includes a plurality of blade receiving slots 44 formed therein in which the slots extend in the lateral direction, perpendicularly to the first longitudinal axis of the lower body portion to span substantially the full width of the main portion of the base member 34. The slots 44 are spaced apart from one another in the longitudinal direction by a spacing corresponding to the spacing between the blades of the blade assembly so that each slot receives a respective one of the blades therein in the closed position. The width of the slots in the longitudinal direction is slightly greater than the thickness of the blades in the longitudinal direction to allow a slight change in angular orientation of each blade relative to the respective slot as the apparatus is displaced from the open position to the closed position due to the blades lying generally parallel to the hinge axis.

In the illustrated embodiment, each blade has a generally square bottom cutting edge which is flat and oriented in the lateral direction. Some of the blades protrude from the second longitudinal axis of the upper body portion and from the common frame member 40 of the blade assembly by a greater distance than other blades. More particularly a first set of blades nearest to the second end of the apparatus are longer while a second centrally located set of blades has an intermediate length slightly shorter than the first set of blades, and a third set of blades nearest to the first end of the apparatus is shorter than either of the first or second sets. In this manner the distance of the cutting edges of the blades from the second longitudinal axis of the upper body portion generally increases with increasing distance of the blades from the hinge axis at the first end of the apparatus.

Turning now to the second embodiment of FIG. 7, in this instance a second configuration of blade assembly 38 is provided which is interchangeable with the blade assembly according to FIG. 6. The blade assembly of FIG. 7 includes half as many blades as the blade assembly of FIG. 6 at twice the longitudinal spacing between the blades. The blade assembly of FIG. 7 can thus be used together with the same base assembly of FIG. 6; however, in this instance every second slot 44 of the base member receives one of the blades therein while the remaining slots are not used and do not receive a blade therein in the closed position. The blades and the frame member 40 of the blade assembly of FIG. 7 are otherwise configured substantially the same as the blade assembly of FIG. 6.

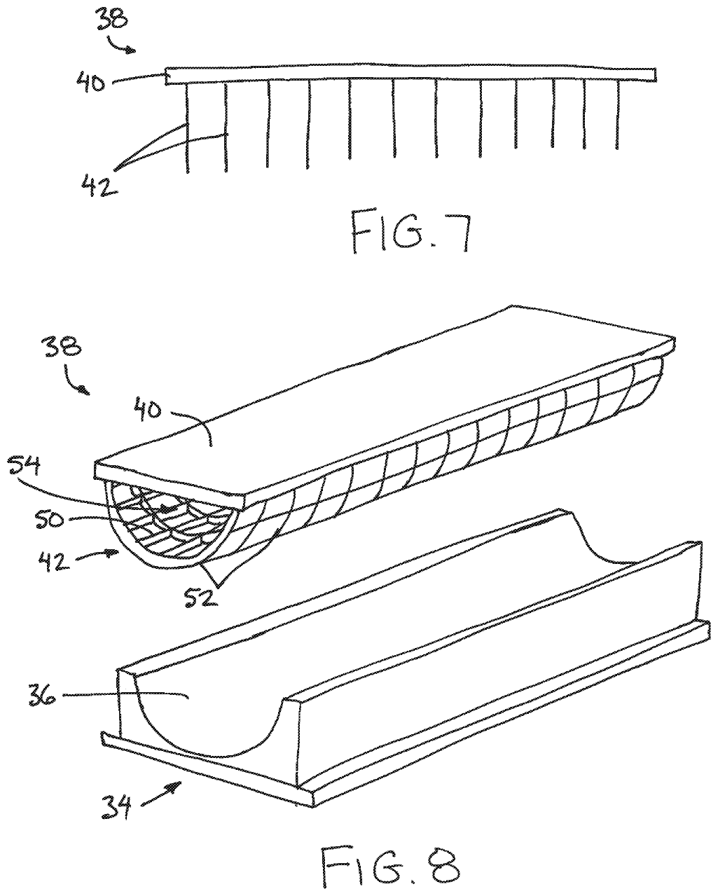

Turning now to the third embodiment of FIG. 8, in this instance the blades include a combination of (i) lateral blades that are parallel to the hinge axis and perpendicular to the second longitudinal axis of the upper blade portion together with (ii) longitudinal blades that are perpendicular to the hinge axis and parallel to the second longitudinal axis of the upper body portion. The lateral blades span substantially the full width of the blade assembly, while the longitudinal blades span substantially the full length of the blade assembly, at evenly spaced apart positions in the longitudinal and lateral directions respectively. In this manner the blades intersect one another to form a generally rectangular grid or mesh pattern. All of the blades in this instance extend generally in a direction from the upper body portion towards the lower body portion between respective inner edges 50 collectively defining an upper boundary of the blades and outer edges 52 collectively forming a lower boundary of the blades. All of the blades generally have a common height between the upper and lower boundaries.

The common lower boundary of the blades according to FIG. 8 is generally curved about the second longitudinal axis of the upper body portion so as to be generally convex in the lateral direction to form part of a cylinder in shape which closely matches the shape of the supporting surface on the lower body portion. In this instance, the cutting edges of all of the blades terminate directly against the supporting surface on the lower body portion when the apparatus is in the closed position.

The common upper boundary of the blades according to FIG. 8 is similarly shaped to the lower boundary so as to be curved about the second longitudinal axis of the upper body portion and to form a concave shape which forms part of a cylinder in shape. The majority of the upper boundary of the blades is spaced below the common frame member 40, particularly along a laterally central portion spanning the full length of the assembly. More particularly a central portion of the blades in the lateral direction is spaced below a central portion of the upper body portion receiving a central portion of the frame therein in the mounted position of the blade assembly on the upper body portion. The shape of the upper boundary of the blades relative to a flat plate that defines the frame member 40 results in a collection space 54 being situated above the upper boundary of the blades and below the frame member. In particular the collection space has a shape corresponding approximately to part of the volume of a cylinder. The collection space is fully open at the second end of the apparatus.

In the embodiment of FIG. 8, the supporting surface of the base member comprises a solid surface which is uninterrupted and devoid of any slots or openings therein along the full length and width thereof. In use, the food item is supported on the supporting surface in the open position of the apparatus. Displacement of the blades towards the closed position causes the lower cutting edges of the blades to pass fully through the food item until the cutting edges of the blades commonly engage and abut the supporting surface. The resulting chopped food item, having been pushed through the mesh of blades, then resides within the collection space 54 above the mesh of blades. The chopped pieces of the food item within the collection space can then be dispensed from the apparatus through the open second end of the collection space.

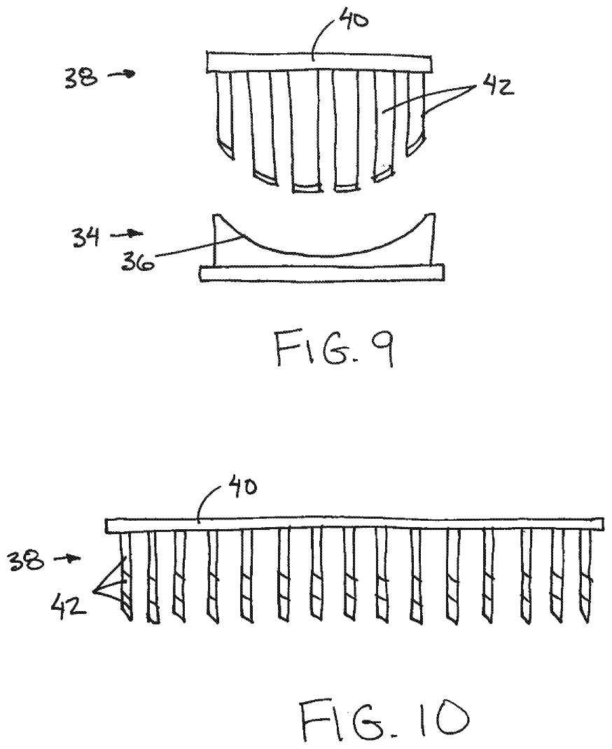

Turning now to the fourth embodiment of FIGS. 9 and 10, in this instance the blades comprise a plurality of elongate fingers connected to the common frame member 40 to protrude perpendicularly outward therefrom towards the opposing lower body portion of the apparatus. The elongated blades are arranged within laterally extending rows in which the individual rows are spaced apart in a longitudinal direction relative to one another. The fingers thus define a rectangular array of fingers which are spaced laterally and longitudinally relative to one another. Each of the fingers defines a bottom cutting edge in which the bottom cutting edges of the fingers terminate within a common lower boundary. Each individual finger is pointed at the bottom end thereof to be tapered and sharpened towards an individual point or a sharpened cutting edge.

The common lower boundary of the cutting edges of the blades is generally curved about the second longitudinal axis of the upper body portion so as to be generally convex in the lateral direction to form part of a cylinder in shape, while closely matching the shape of the supporting surface on the lower body portion. In this instance, the cutting edges of all of the blades terminate directly against the supporting surface on the lower body portion when the apparatus is in the closed position. The supporting surface of the base member in this instance again comprises a solid surface which is uninterrupted and devoid of any slots or openings therein along the full length and width thereof similarly to the base member of FIG. 8. In use, a food item is placed on the supporting surface of the lower body portion in the open position of the apparatus and the apparatus is subsequently closed so that the fingers cut into the food item. The elongate fingers are provided in sufficient numbers and at an appropriate spacing relative to one another to cause the food item to be broken up into many smaller pieces by a combination of cutting and/or crushing of the food item.

Due to the interchangeability of the base member of the lower body portion and the blade assembly of the upper body portion, use of the apparatus generally begins by the user selecting whether the food item is to be sliced into thin slices according to the first embodiment of FIGS. 1 to 6, sliced into thick slices according to the second embodiment of FIG. 7, diced into a rectangular grid of pieces according to the third embodiment of FIG. 8, or crushed into a multitude of individual pieces according to the fourth embodiment of FIGS. 9 and 10. In either instance, the food item, for example a hot pepper, can be placed on the supporting surface while in the open position, followed by closing of the apparatus to effect the chopping in a manner which does not require any direct contact of the hot pepper with the fingers of the user. The chopped food item can then be readily discharged through the open second end of the apparatus opposite to the hinge by again opening the apparatus in some embodiments, or by simply discharging through the open end of the blade assembly in the embodiment of FIG. 8 for example. In either instance, no contact with the hands of the user is required to discharge the chopped food item from the apparatus.

Since various modifications can be made in my invention as herein above described, and many apparently widely different embodiments of same made, it is intended that all matter contained in the accompanying specification shall be interpreted as illustrative only and not in a limiting sense.

1. A chopping apparatus for chopping a food item, the apparatus comprising:
a lower body portion which is elongate in a first longitudinal direction between a first end and an opposing second end of the lower body portion so as to define a lower longitudinal axis extending between the first end and the second end of the lower body portion;
an upper body portion which is elongate in a second longitudinal direction between a first end and an opposing second end of the upper body portion so as to define an upper longitudinal axis extending between the first end and the second end of the upper body portion;
a hinge coupled between the first end of the lower body portion and the first end of the upper body portion, the hinge defining a hinge axis that is perpendicular to the first and second longitudinal directions such that the upper body portion is pivotal relative to the lower body portion between (i) a closed position in which the upper body portion lies substantially parallel to and alongside the lower body portion, and (ii) an open position in which the upper body portion diverges away from the lower body portion from the first end towards the second end thereof;
a supporting surface on the lower body portion, the supporting surface facing towards the upper body portion and being arranged to support the food item thereon, and the supporting surface being curved about a longitudinal axis oriented in the first longitudinal direction so as to be concave and partly cylindrical in shape;
a plurality of blades supported on the upper body portion, each blade extending towards the lower body portion from an upper end mounted on the upper body portion to a lower end defining a cutting edge thereon;
the blades being spaced apart from the supporting surface in the open position so as to be arranged to receive the food item between the blades and the supporting surface;
the blades being located in close proximity to the supporting surface in the closed position so as to be arranged to chop the food item supported on the supporting surface.

2. The apparatus according to claim 1 wherein the blades are supported on a frame and the frame is slidably received into a channel on the upper body portion so as to be readily releasable from the upper body portion.

3. The apparatus according to claim 2 wherein the channel supports the frame for sliding in the second longitudinal direction of the upper body portion.

4. The apparatus according to claim 1 wherein the supporting surface is formed on a base member, the base member being received into a channel on the lower body portion so as to be readily releasable from the lower body portion.

5. The apparatus according to claim 1 wherein at least some of the blades that are in proximity to the second end of the upper body portion protrude farther from the second longitudinal axis of the upper body portion than at least some of the blades that are in proximity to the first end of the upper body portion.

6. The apparatus according to claim 1 further comprising a handle member fixedly attached to a supporting body portion comprising one of the upper body portion and the lower body portion, the handle member extending in the longitudinal direction of the supporting body portion diametrically opposite to the supporting surface in relation to the hinge axis.

7. The apparatus according to claim 1 wherein the blades comprise lateral blades oriented perpendicularly to the second longitudinal direction of the upper body portion upon which the blades are supported.

8. The apparatus according to claim 7 wherein the supporting surface includes a plurality of slots formed therein, the slots receiving the lateral blades therethrough in the closed position of the upper body portion relative to the lower body portion.

9. The apparatus according to claim 1 wherein the supporting surface is continuous and uninterrupted along a length of the supporting surface in the first longitudinal direction of the lower body portion.

10. The apparatus according to claim 9 wherein the blades include longitudinal blades and the lateral blades arranged in an intersecting manner to define a mesh, the mesh having convex lower boundary similar in shape to the supporting surface on the lower body portion and a concave upper boundary, the mesh being spaced below a central portion of the upper body portion to define a collection space above the concave upper boundary of the blades, the collection space being arranged to receive chopped pieces of the food item therein once the mesh has passed through the food item as a result of displacement of the upper body portion into the closed position.

11. The apparatus according to claim 9 wherein the blades comprise an array of elongate fingers arranged in longitudinally spaced apart rows, the fingers all terminating at a lower boundary that is similar in shape to the supporting surface such that all of the fingers are arranged to engage the supporting surface in the closed position of the upper body portion relative to the lower body portion.
